(19) United States
(12) Patent Application Publication
(10) Pub. No.: US 2017/0084385 A1
(43) Pub. Date: Mar. 23, 2017

(54) Surface-Mount Inductor and Method Of Producing The Same

(71) Applicant: TOKO, INC., Tsurugashima-shi (JP)

(72) Inventor: Koichi IDA, Tsurugashima-shi (JP)

(21) Appl. No.: 15/080,835

(22) Filed: Mar. 25, 2016

(30) Foreign Application Priority Data
Apr. 10, 2015 (JP) 2015-080682

(51) Int. Cl. H01F 27/29; B05D 1/02; H01F 41/02; H01F 27/255; H01F 27/28

(52) U.S. Cl. CPC H01F 27/292; H01F 27/255; H01F 27/2823; H01F 41/02; B05D 1/02

(57) ABSTRACT

A surface-mount inductor with a lower-surface electrode structure is provided. In the surface-mount inductor, a winding wire is buried in such a manner as to allow each of terminal ends of the winding wire to be exposed on a respective one of the end surfaces of an element body. An external electrode is provided in the end surfaces, the upper and lower surfaces, and at an end portion of each of the opposed side surfaces of an element body. The element body has an outer periphery coated with an insulating resin, except for at least the lower surface.

### BACKGROUND OF THE INVENTION

1. Field of the Invention

This application is based on Japanese Patent Application No. 2015-080682 filed on Apr. 10, 2015 as the basic application.

The present invention relates to a surface-mount inductor and a method of producing the same.

2. Description of the Related Art

There has been heretofore widely used an inductor comprising a winding wire sealed with a magnetic resin which is obtained by mixing and kneading magnetic powders and a resin, as disclosed, for example, in JP 2010-245473A.

In a conventional surface-mount inductor production method, a wire having a rectangular cross-section is wound in two-tiered spiral pattern in such a manner as to allow its opposite terminal ends to be positioned on an outermost periphery (alpha winding), an element body is created which comprises a winding wire buried in a magnetic resin having an rectangular parallelepiped outer shape in such a manner as to allow its opposite terminal ends to be exposed on the opposed end surfaces, and the end surfaces of the element body are immersed in an electrically-conductive paste in which metal particles such as Ag are dispersed in a thermosetting resin such as an epoxy resin, to thereby form an electrode across the end surfaces and peripheries adjoining the end surfaces. Hereinafter, this type of electrode structure is referred to as a five-sided electrode structure.

### BRIEF SUMMARY OF THE INVENTION

### Problem to be Solved by the Invention

In a surface-mount component, a solder fillet is generally formed between an electrode and a footprint. Thus, electronic component of five-sided electrode structure has a problem that the footprint becomes larger, requiring a larger clearance between the components, and if the components are closely arranged to each other, the fillet between the components will be undesirably bridged. For this reason, when a high-density mounting is required, electronic components with a lower-surface electrode structure, in which electrode is formed only at opposed ends of the lower surface, are frequently used.

In the surface-mount inductor, a surface-mount inductor with a lower-surface electrode structure is desirable as well. However, in the conventional structure of surface-mount inductor, it is difficult to pull out terminal ends of the winding wire from the lower surface to form an electrode only in the lower surface.

### Means for Solving the Problem

The surface-mount inductor according to the present invention comprises: a winding wire; an element body; and an external electrode, wherein the element body comprises a magnetic powder resin comprising magnetic powders and an insulating resin, and is a rectangular parallelepiped-shaped element body having a pair of end surfaces, upper and lower surfaces, and opposed side surfaces, each of the upper, lower and side surfaces connecting between the end surfaces, wherein the winding wire is buried in such a manner as to allow each of terminal ends of the winding wire to be exposed on respective one of the end surfaces of the element body, wherein the external electrode is provided in the end surfaces, the upper and lower surfaces, and at an end portion of each of the opposed side surfaces, each of the upper, lower and side surfaces adjoining the end surfaces, and wherein the element body has an outer periphery coated with an insulating resin, except for at least the lower surface.

### Effect of the Invention

According to the present invention, it is possible to allow a surface-mount inductor with a conventional five-sided electrode structure to be produced as a lower-surface electrode structure in a simple way.

### BRIEF DESCRIPTION OF THE DRAWINGS

FIG. 1 is a perspective view of a surface-mount inductor according to the present invention, with a lower surface up.

FIG. 2 is a vertical cross-sectional view of the surface-mount inductor according to the present invention.

FIGS. 3A to 3D are illustration for explaining a method of producing the surface-mount inductor according to the present invention.

FIG. 4 is a surface photograph of a surface-mount inductor of a comparative example.

FIG. 5 is a surface photograph of a surface-mount inductor of sample 1.

FIG. 6 is a surface photograph of a surface-mount inductor of sample 2.

FIG. 7 is a surface photograph of a surface-mount inductor of sample 3.

FIG. 8 is a surface photograph of a surface-mount inductor of sample 4.

FIG. 9 is a surface photograph of a surface-mount inductor of sample 5.

FIG. 10 is a surface photograph of a surface-mount inductor of sample 6.

FIG. 11 is a surface photograph of a surface-mount inductor of sample 7.

FIG. 12 is a surface photograph of a surface-mount inductor of sample 8.

FIG. 13 is a surface photograph of a surface-mount inductor of sample 9.

FIG. 14 is a cross-sectional photograph of a surface-mount inductor of a third embodiment.

### DETAILED DESCRIPTION OF THE INVENTION

A structure of a surface-mount inductor of the present invention will now be described with reference to the drawings.

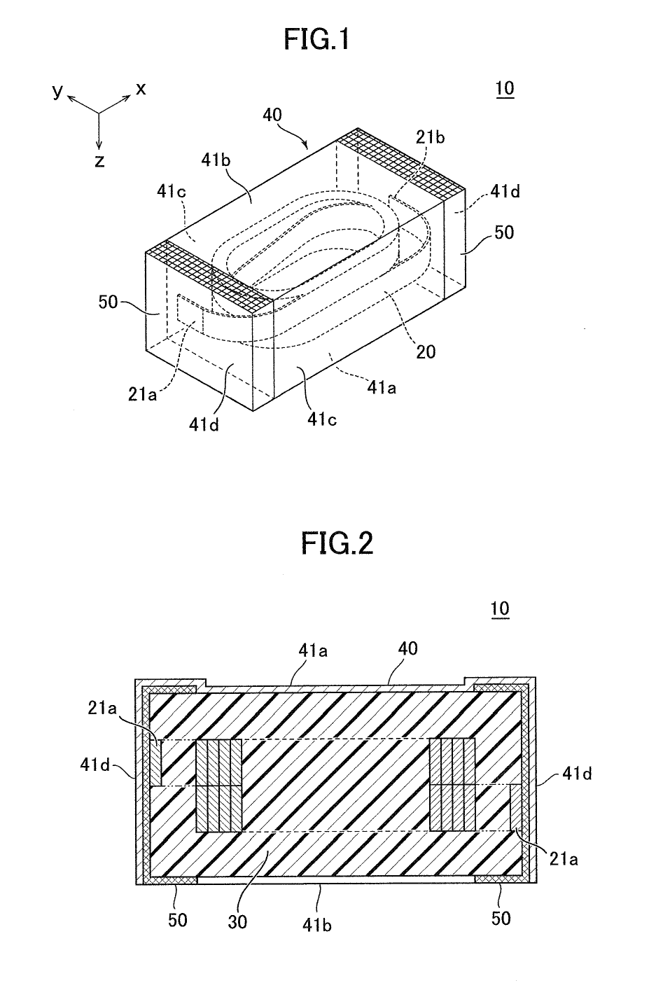

FIG. 1 is a perspective view of one embodiment of a surface-mount inductor according to the present invention, with a lower surface up, and FIG. 2 illustrates a vertical cross-sectional view thereof.

As illustrated in FIGS. 1 and 2, a surface-mount inductor 10 comprises a winding wire 20, an element body 40, and an electrode 50. The element body 40 is obtained by forming a magnetic resin 30 to have a rectangular outer shape. The winding wire 20 is buried in the element body 40 in such a manner as to allow each of its terminal ends 21a, 21b to be exposed on respective one of the opposed end surfaces 41d, 41d of the element body 40. The electrode 50 is formed by applying an electrically-conductive paste to the end surfaces 41d, 41d, and to the periphery of upper and lower surfaces 41a, 41b and side surfaces 41c, 41c to which the end surfaces 41d, 41d adjoin. The element body 40 has an outer periphery coated with an insulating resin layer 60, except for the lower surface 41b.

As the winding wire 20, a type is used which is obtained by winding an electrically-conductive wire having a rectangular cross-section in two-tiered spiral pattern in such a manner as to allow its opposite terminal ends to be positioned on an outermost periphery (alpha winding).

As the magnetic resin 30, a type is used in which iron-based metal magnetic powders and an epoxy resin are mixed and granulated into powders.

As the electrically-conductive paste, a type is used in which metal particles such as Ag are dispersed in a thermosetting resin such as an epoxy resin.

As the insulating resin layer 60, an epoxy resin is used.

### [First Production Method]

Next, a method of producing the surface-mount inductor according to the present invention will be described.

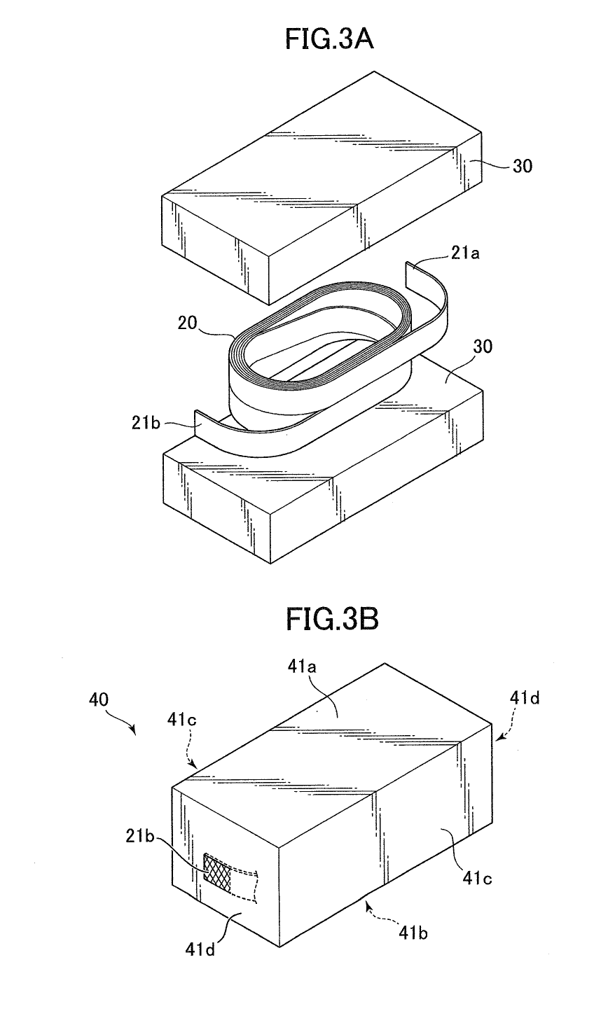

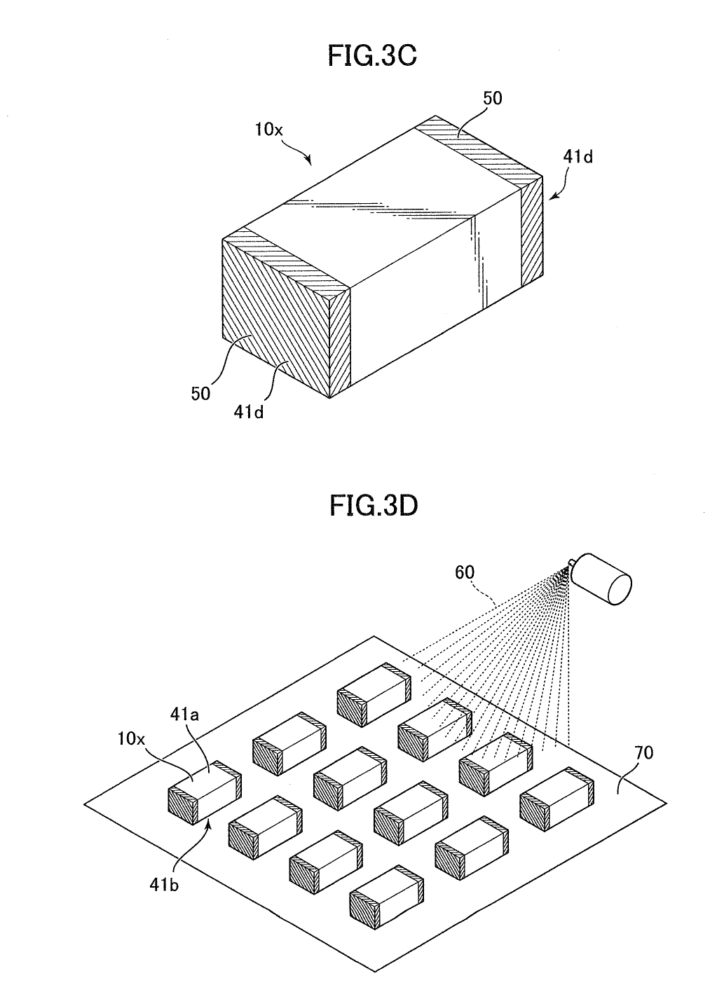

FIGS. 3A to 3D are illustrations for explaining a first production method of the surface-mount inductor according to the present invention.

### (Element Body Creating Process)

First, as illustrated in FIG. 3A, the winding wire 20 is provided which is wound in two-tiered spiral pattern in such a manner as to allow its opposite terminal ends to be positioned on an outermost periphery (alpha winding), and is buried in the magnetic resin 30 such that its terminal ends 21a, 21b are exposed, to thereby create the element body 40 in a compression molding process.

Next, as illustrated in FIG. 3B, a coating (hatched in the figure) on a surface of each of the terminal ends 21a, 21b exposed on the opposed end surfaces 41d, 41d of the element body 40 is removed by mechanical stripping, etc.

### (Electrode Forming Process)

Next, as illustrated in FIG. 3C, the end surfaces 41d, 41d are immersed in the electrically-conductive paste, which are then subject to heat treatment to form external electrodes 50, 50 (slashed in the figure), to thereby obtain a surface-mount inductor 10x.

### (Spray-Coating Process)

Then, as illustrated in FIG. 3D, a plurality of surface-mount inductors 10x are placed at intervals on a UV-strippable adhesive sheet 70, with the lower surface 41b down, which are then applied with the thermosetting insulating resin 60 by a spray-coating method and are subject to heat treatment.

As the insulating resin, a type is used in which a commonly used epoxy resin is diluted with ethyl cellosolve.

In this way, a surface-mount inductor having an electrode coated with the insulating resin layer, except for the lower surface 41b, can be obtained.

### (Plating Process)

Finally, by irradiating a UV on the adhesive sheet to weaken the adhesiveness, removing the surface-mount inductors 10x from the adhesive sheet, and applying nickel plating and tin plating in sequence by barrel plating, the surface-mount inductor 10 is obtained.

### [Second Production Method]

When the thickness of the insulating resin layer is 5 μm or less, the layer is peeled in the plating process. Thus, a certain degree of thickness is required for the insulating resin layer, but, in the spray-coating method, thicker coating causes so-called corrugation on the surface of the surface-mount inductor.

Then, an insulating resin is spray-coated, which comprises ethyl cellosolve as a first solvent to which a second solvent capable of dissolving the epoxy resin and having higher evaporation rate than that of the ethyl cellosolve is further added. This allows the insulating resin layer to be leveled to inhibit the corrugation.

Table 1 shows characteristics and leveling states of solvents in the case of spray-coating the surface-mount inductor with an insulating resin only with the first solvent, and an insulating resin with various solvents added thereto as the second solvent.

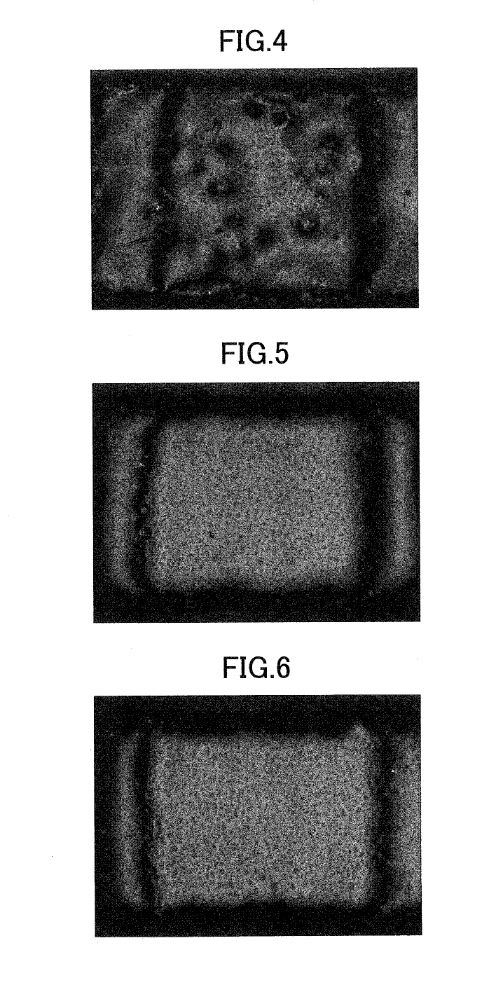

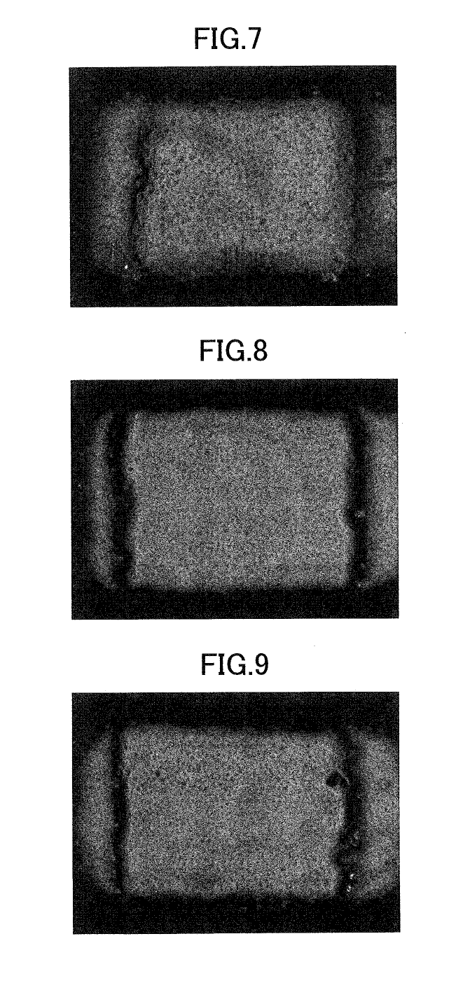

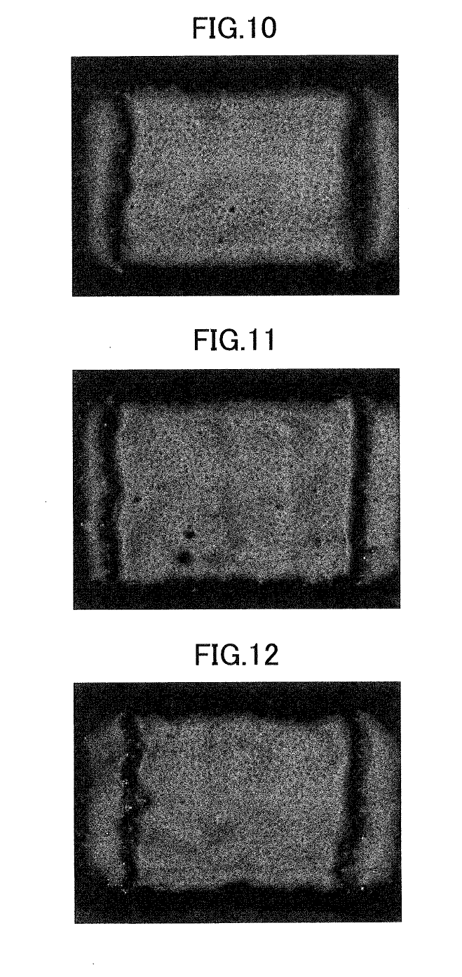

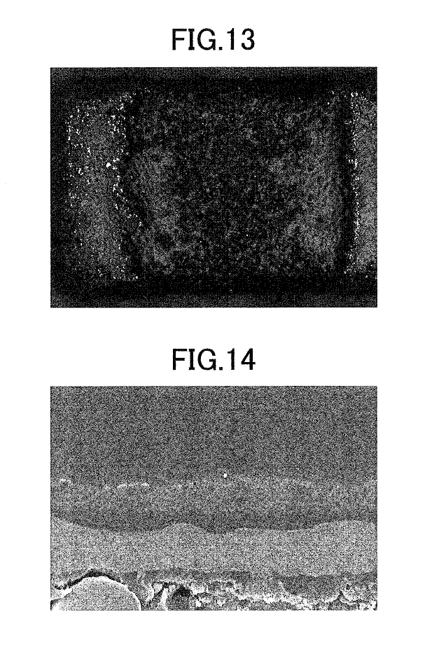

FIG. 4 illustrates a comparative example, and each of FIGS. 5 to 13 illustrates a surface photograph of a surface-mount inductor of each of samples 1 to 9

TABLE 1

| | | | Evaporation | | |
|---|---|---|---|---|---|
| | | | rate of | | |
| | | | second | Epoxy | |
| | | | solvent with | resin-solubility | |
| | First | | respect to | of second | |
| | solvent | Second solvent | first solvent | solvent | Leveling |
| Comparative | Ethyl | N/A | — | — | Poor |
| example | cellosolve | | | | |
| Sample 1 | | Xylene | Fast | Soluble | Excellent |
| Sample 2 | | Methyl ethyl | Very fast | Very soluble | Good |
| | | ketone | | | |
| Sample 3 | | Acetone | Very fast | Very soluble | Fair |
| Sample 4 | | Methyl | Fast | Very soluble | Fair |
| | | cellosolve | | | |
| Sample 5 | | Toluene | Fast | Soluble | Fair |
| Sample 6 | | Cyclohexanone | Fast | Soluble | Fair |
| Sample 7 | | Propylene | Fast | Soluble | Fair |
| | | glycol | | | |
| | | monomethyl | | | |
| | | ethyl acetate | | | |
| Sample 8 | | Propylene | Fast | Soluble | Fair |
| | | glycol | | | |
| | | monomethyl | | | |
| | | ether | | | |
| Sample 9 | | Isopropyl | Fast | Not soluble | Poor |
| | | alcohol | | | |

It can be seen from a result of the Table 1 that it becomes possible to allow the coating to be leveled to inhibit the corrugation by adding xylene, methyl ethyl ketone, methyl cellosolve, toluene, cyclohexanone, propylene glycol monomethyl ethyl acetate, and propylene glycol monomethyl ether, and more preferably xylene and methyl ethyl ketone, each being capable of dissolving the epoxy resin and having higher evaporation rate than that of the ethyl cellosolve.

### [Third Production Method]

To have a thicker coating, and to suppress glazing of the surface which becomes an impediment of machine vision, silica may be added to the insulating resin.

In an insulating resin applying process, an insulating resin which does not contains silica is first spray-coated (first insulating resin applying process), and then an insulating resin which contains filler is spray-coated (second insulating resin applying process). As the filler, for example, silica, boron nitride, and alumina are usable.

FIG. 14 illustrates a cross-sectional photograph of a surface-mount inductor produced by the third production method. As the filler, silica having a diameter of 1.5 μm which is greater than minimum particle diameter of the magnetic powder is used and mixed in the same amount as components making up the insulating resin.

In the above embodiment, the plating process is performed after the insulating resin applying process. Alternatively, the plating process may be performed after the electrode forming process.

Further, a dip method is used as the application method of the electrically-conductive paste. Alternatively, methods such as printing and potting may also be used.

Further, the external electrode may be formed from copper plating or calcined silver.

In the applying process, by placing the adjacent surface-mount inductors with their end surfaces being in contact with each other and their side surfaces being spaced from each other, it is possible to mask not only the lower surfaces, but also the end surfaces easily. As the result, a surface-mount inductor with so-called L-shaped electrode, in which the electrode is only exposed at opposite ends of the lower end and in the opposed end surfaces, can be achieved.

### EXPLANATION OF CODES

10, 10x: surface-mount inductor
20: winding wire
21a, 21b: terminal end
30: magnetic resin
40: element body
41a: upper surface, 41b: lower surface, 41c: side surface, 41d: end surface
50: electrode
60: insulating resin
70: adhesive sheet

1. A surface-mount inductor, comprising: a winding wire; an element body; and an external electrode,
wherein the element body comprises a magnetic powder resin comprising magnetic powders and an insulating resin, and is a rectangular parallelepiped-shaped element body having a pair of end surfaces, upper and lower surfaces, and opposed side surfaces, each of the upper, lower and side surfaces connecting between the end surfaces,
wherein the winding wire is buried in such a manner as to allow each of terminal ends of the winding wire to be exposed on respective one of the end surfaces of the element body,
wherein the external electrode is provided in the end surfaces, the upper and lower surfaces, and at an end portion of each of the opposed side surfaces, each of the upper, lower and side surfaces adjoining the end surfaces, and
wherein the element body has an outer periphery coated with an insulating resin, except for at least the lower surface.

2. The surface-mount inductor as defined in claim 1, wherein the external electrode is formed from copper plating, silver paste, or calcined silver.

3. The surface-mount inductor as defined in claim 2, wherein the external electrode has a nickel-plated layer and a tin-plated layer.

4. A method of producing a surface-mount inductor, the method comprising the steps of:
providing an element body in which a winding wire is buried, wherein the element body comprises a magnetic powder resin comprising magnetic powders and an insulating resin, and is a rectangular parallelepiped-shaped element body having a pair of end surfaces, upper and lower surfaces, and opposed side surfaces, each of the upper, lower and side surfaces connecting between the end surfaces, and wherein each of the terminal ends of the winding wire is exposed on respective one of the end surfaces of the element body;
applying an electrically-conductive resin to the end surfaces, the upper and lower surfaces, and an end portion of each of the side surfaces;
spray-coating an outer periphery of the element body with an insulating resin, except for at least the lower surface;
providing a nickel plated layer on the electrically-conductive resin of the element body which is not spray-coated; and
applying tin-plating to the nickel plated layer.

5. The method as defined in claim 4, wherein the insulating resin comprises:
an epoxy resin;
a first solvent capable of dissolving the epoxy resin; and
a second solvent capable of dissolving the epoxy resin and having higher evaporation rate than that of the first solvent.

6. The method as defined in claim 4, wherein the step of spray-coating comprises a first spray-coating process and a second spray-coating process.

7. The method as defined in claim 6, wherein the first spray-coating process spray-coats an insulating resin which does not contain a filler, and the second spray-coating process spray-coats an insulating resin which contains a filler.

8. The method as defined in claim 7, wherein the filler is silica, alumina, or boron nitride.

9. The method as defined in claim 7, the filler has an average particle size that is greater than that of the insulating resin.

10. The method as defined in claim 5, wherein the first solvent is ethyl cellosolve, and the second solvent is any of xylene, methyl ethyl ketone, methyl cellosolve, toluene, cyclohexanone, propylene glycol monomethyl ethyl acetate, and propylene glycol monomethyl ether.
